(19) United States
(12) Patent Application Publication
(10) Pub. No.: US 2006/0213375 A1
(43) Pub. Date: Sep. 28, 2006

(54) Fruit and vegetable juicer

(75) Inventor: Gary D. Moline, Upland, CA (US)

Correspondence Address: ROTH & GOLDMAN, P.A., 523 W. 6TH STREET, SUITE 707, LOS ANGELES, CA, 90014, US

(73) Assignee: Moline Manufacturing Co., Inc., San Dimas, CA (US)

(21) Appl. No.: 11/087,527

(22) Filed: Mar. 23, 2005

(51) Int. Cl. A47J 43/14

(52) U.S. Cl. 99/495

(57) ABSTRACT

A juicer attachment which can be latched onto a motor housing includes an upper cover and a lower cover attached to said upper cover to define a gear chamber. The drive for a rotary straining and juicing basket includes telescopically engaged upper and lower drive shafts with spaced heat dissipating bushings and speed reduction gears in the gear chamber. At least one spring biases at least one drive shaft upwardly to normally disengage at least two gears in the chamber so that the motor can be left running while the rotary parts of the juicer attachment remain stationary.

### CROSS REFERENCE TO RELATED APPLICATIONS, IF ANY

None

### BACKGROUND OF THE INVENTION AND PRIOR ART

The present invention relates generally to fruit and vegetable juicers. A fully electrically powered juicer which requires no manual manipulation of the fruit or vegetables to be juiced is disclosed in my prior U.S. Pat. No. 6,050,180 issued Apr. 18, 2000.

The juicer of the present invention is electrically powered but has a top with an upwardly extending head of generally rounded conical shape with protrusions against which a fruit or vegetable to be juiced may be held manually and rotated manually while the head is also rotated under power supplied by an electric motor. The motor may be provided in a lower housing to which a separate juicer attachment may be attached when desired or the motor housing and juicer may be permanently attached together.

A cross sectional view of a juicer attachment of the prior art is shown in FIG. 2 and comprises an upper cover and lower cover defining a gear chamber therebetween. The upper cover has a slotted bottom wall which forms a juice drain and a rotary straining and juicing basket is mounted onto an upper part of a drive shaft having a lower part powered by a motor in a lower housing (not shown) to which the juicer attachment can be attached by latches, for example. In this arrangement, a motor output shaft having an upwardly facing friction contact disc, not shown, supplies power to a friction contact disc on the end of a drive shaft in the attachment which is exposed below the lower cover containing the gear train. The lower part of the drive shaft in the attachment has a pinion gear affixed thereto and the pinion gear is continuously engaged with the outer teeth of a speed reduction gear which has inner teeth engaged with an output gear affixed to drive the upper part of the drive shaft to drive the attached rotary straining and juicing basket. The preferred gear arrangement reduces the speed of the motor output, typically about 3600 RPM to drive the basket at a speed of about 200 RPM—an 18:1 reduction.

It has been found that heat buildup and bearing failure is a substantial problem in the prior art juicers discussed above because the motor is frequently left on for long periods of time, particularly in commercial establishments such as restaurants and because the motor is always attached in driving relationship to the jrotary straining and juicing basket.

### OBJECT OF THE INVENTION

An improved juicer or juicer attachment in which heat build up and wear induced by operation of the motor for protracted periods of time is significantly reduced and which is suitably quiet in operation is therefore desired.

### SUMMARY

Disclosed herein is an electrically powered juicer which includes a motor housing, a gear cover and a rotary straining and juicing basket having a protruding juicer head for engaging fruit or vegetables to be juiced. The gear cover is preferably latched to the motor housing but may be affixed by other means to the motor housing.

More particularly, a separate juicer attachment is disclosed for mounting on a housing containing a motor having a rotary drive shaft. The attachment comprises:

a) an upper cover having a side wall and a bottom wall having an aperture for receiving a drive shaft;

b) a lower cover having an aperture for receiving a drive shaft, the lower cover being attached to the upper cover, the upper and lower covers defining a gear chamber;

c) an upper drive shaft slidably mounted in the aperture in the upper cover;

d) a rotary straining and juicing basket supported on the upper drive shaft in the upper cover;

e) a lower drive shaft telescopically engaged with and rotatable relative to the upper drive shaft, the lower drive shaft having a drive coupling thereon for engaging a drive coupling s driven by a motor;

f) gears in the gear chamber for transferring power from the lower drive shaft to the upper drive shaft; and

g) at least one spring biasing at least one of the upper and lower drive shafts upwardly relative to the covers to normally disengage at least two gears in the chamber.

### BRIEF DESCRIPTION OF THE DRAWINGS

FIG. 1 is a perspective view, partially broken away, of a juicer attachment which can be latched to a motor housing.

FIG. 2 is a cross sectional elevation view of a prior art juicer attachment.

FIG. 3 is a cross sectional elevation view of a presently preferred embodiment of a juicer attachment in accordance with the present invention.

FIG. 4 is a top plan view of a rotary straining and juicing basket.

FIG. 5 is a side view of a lower drive shaft to an enlarged scale.

FIG. 6 is an elevation view of an upper drive shaft to an enlarged scale.

FIG. 7 is an elevation view of an upper mounting bushing and compression spring to an enlarged scale.

FIG. 8 is a perspective view of a juicer which includes the attachment of FIG. 1 latched to a motor housing.

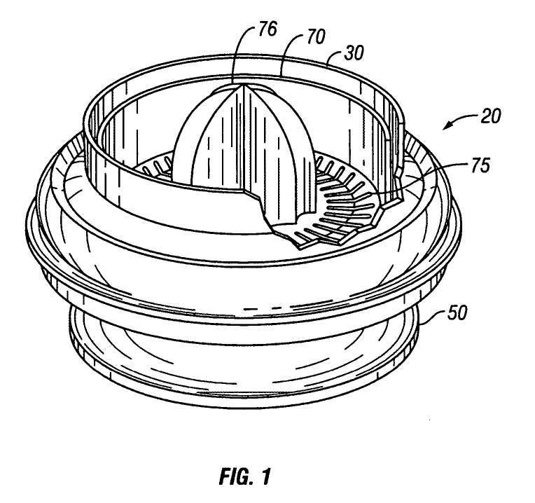

### DESCRIPTION OF THE PREFERRED EMBODIMENT

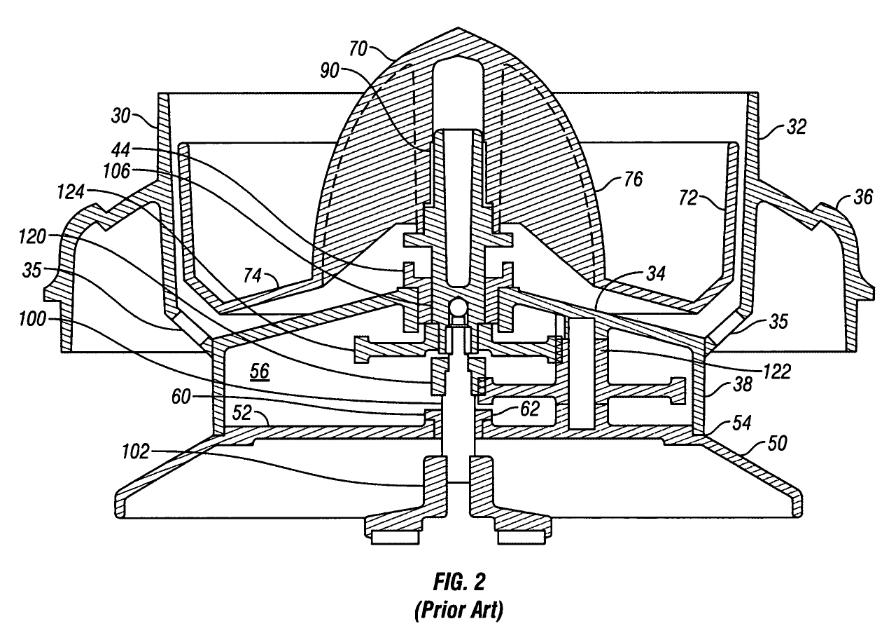

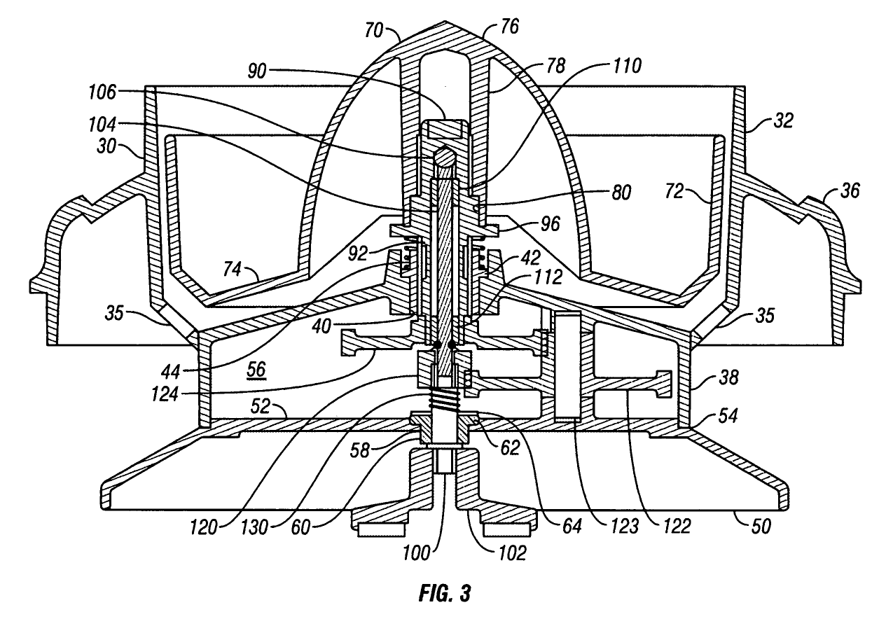

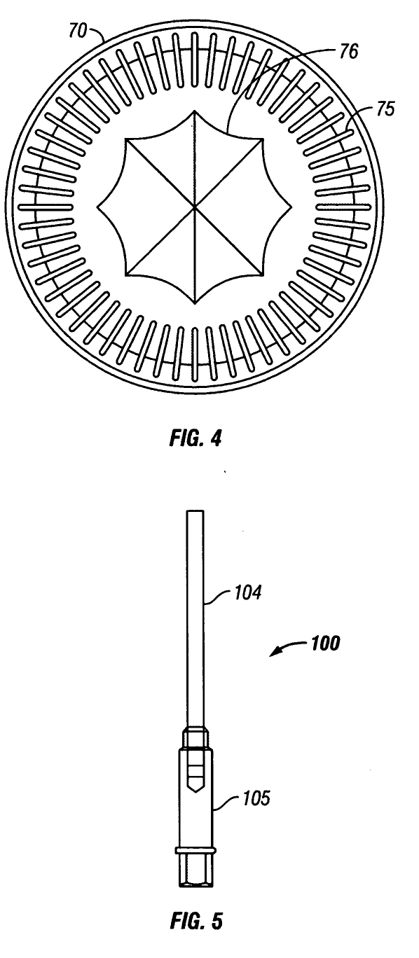

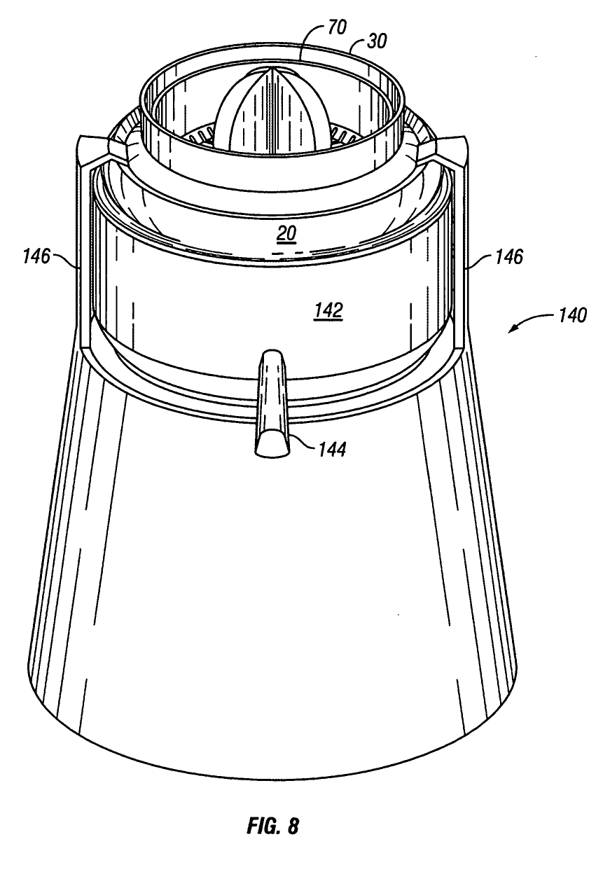

As best seen in FIG. 2, the juicer attachment 20 includes an upper cover 30, preferably of molded plastic, having a side wall 32 and a bottom wall 34. Openings 35 in the lower portion of the side wall 32 near its juncture with the bottom wall 34 form juice drains. A peripherally extending splash skirt 36 may also be integrally formed on the upper cover 30 which also includes a downwardly extending cylindrical wall 38. A central aperture 40 is provided in the bottom wall 34, preferably with an upwardly facing shoulder 42 to form a seat for receiving an upper mounting bushing 44 for a drive shaft to be described below. The upper mounting bushing 44 preferably comprises an integrally formed sleeve and collar 46 (FIG. 7) of lubricious material such as PEEK (polyetheretherketone) mounted in the aperture 40 as shown. The collar 46 provides a lower seat for a compression spring 98 described below.

The attachment 20 further includes a lower cover 50, also preferably formed of molded plastic, having a top wall 52 with a peripheral groove 54 forming a seat for receiving the lower end of the cylindrical wall 38 of the upper cover 30 such that the covers 30, 50 may be connected together, by screws or in any other suitable manner, to form a gear chamber 56. The top wall 52 also includes a central aperture 58 which provides a seat for a lower mounting bushing 60 for the drive shaft. The lower mounting bushing 60 preferably comprises an integrally formed sleeve and collar 62 of lubricious material such as PEEK and a washer 64 preferably formed of nylon seated on the upper surface of the collar 62.

A rotary straining and juicing basket 70 is supported on the upper end of an upper drive shaft and includes a side wall 72, a bottom wall 74 having perforations preferably formed as slots 75, an upwardly extending juicer portion 76 in the form of a rounded cone having projections for engaging fruit to be juiced and a downwardly extending drive sleeve 78 having inwardly facing one way drive cam surfaces 80.

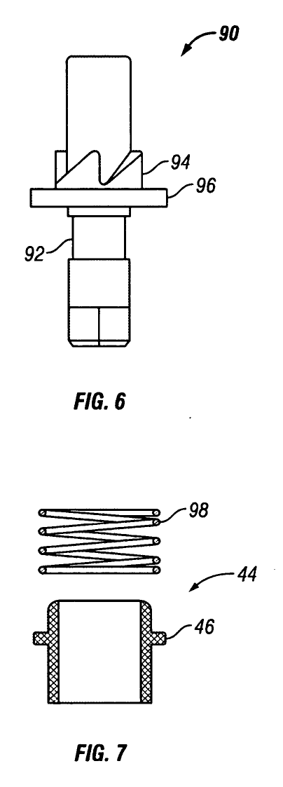

The rotary straining and juicing basket 70 is rotated by an upper drive shaft 90 10 having a downwardly extending sleeve 92 slidably mounted in the upper mounting bushing 44 in the central aperture 40 in bottom wall 34 of the upper cover 30. The upper end of the upper drive shaft 90 is received in the downwardly extending drive sleeve 78 of the juicer basket 70. One way drive cam surfaces 94 (FIG. 6) on the upper end of the upper drive shaft 90 engage the cam surfaces 80 on the inner surface of the sleeve 78 so that the upper drive shaft 90 can rotate the juicer basket 70 in only one direction. A collar 96 on the upper drive shaft 90 provides an upper seat for a coil compression spring 98 (FIG. 7) which upwardly biases the upper drive shaft 90 and rotary straining and juicing basket 70.

The upper drive shaft 90 is telescopically connected to a lower drive shaft 100 having a lower end extending through the lower mounting bushing 60 and washer 64. A drive coupling 102 is affixed to or formed on the lower end of the lower drive shaft 100. In the embodiment shown, the drive coupling 102 is in the form of a disc having a lower face, preferably of rubber or synthetic material which provides a friction surface for engagement with similar friction surface on an upwardly facing end of a drive coupling on the upper end of a drive shaft (not shown) of an electric motor contained in a lower housing 140 which includes a n upwardly facing receptacle 142 with a spout 144, shown in FIG. 8, to which the juicer attachment 20 can be attached, as by latches 146 so that juice drains from the openings 35 to the receptacle 142 and spout 144. The lower drive shaft 100, shown in FIG. 5, includes an upwardly extending rod 104 of reduced diameter which is slidably received in the upper drive shaft 90. The rod 104 is preferably made of metal and, as shown, may be affixed by a suitable adhesive in a bore in a lower portion 105 made of plastic. A thrust ball 106 is positioned in an axially extending bore in the upper drive shaft 90 and contacts both the upper drive shaft 90 and the lower drive shaft 100. Spaced bushings 110, 112, preferably of PEEK, are provided between upper drive shaft 90 and the upwardly extending rod 104 at upper and lower ends of an axially extending annular heat dissipating cavity between the bushings 110, 112.

A gear train is enclosed in the gear chamber 56 for reducing the rotary speed imparted to the lower drive shaft 100 by the motor drive shaft, typically about 3600 RPM, to rotate the upper drive shaft 90 and attached rotary straining and juicing basket 70 at a speed of about 200 RPM—i.e., a reduction ratio of 18:1 in the preferred embodiment. The gear train may take any suitable configuration and include any suitable number of gears for establishing a speed reduction ratio of choice. In the arrangement shown, the gear train is comprised of a pinion gear 120 non-rotatably affixed to the lower drive shaft 100, a speed reduction gear 122 having outer teeth and inner teeth, and an output gear 124. The speed reduction gear 122 is mounted on a shaft s 123 extending between seats formed in the upper and lower covers 30, 50. The outer teeth of the speed reduction gear 122 are normally disengaged from the teeth of the pinion gear 120 due to the upward bias of spring 98 on the upper drive shaft 90 and the inner teeth of the speed reduction gear 122 are continuously engaged with the teeth of the output gear 124 which is non-rotatably affixed to the sleeve 92 of the upper drive shaft 90. The teeth of the pinion gear 120 are engaged 10 when desired with the outer teeth of the speed reduction gear 122 by pushing a fruit or vegetable to be juiced downwardly onto the juicer cone 76 against the bias of spring 98. The rotary straining and juicing basket 70 then pushes the upper drive shaft 90 and the lower drive shaft 100 therein downwardly against the bias of the spring 98 and against the bias of another coil compression spring 130 mounted on the lower drive shaft 100 and seated between the lower face is of the pinion gear 120 and the washer 64 on the lower mounting bushing 60 to bring the teeth of the pinion gear 120 into horizontal alignment with the outer teeth of the speed reduction gear 122. The springs 98 and 130 thus function to normally disengage at least two gears in the gear chamber 62. Those skilled in the art will understand other configurations of springs which do not encircle the lower drive shaft may be substituted.

In the arrangement described, the spaced bushings 110, 112 between the upper drive shaft 90 and the lower drive shaft 100 ensure concentric alignment of the two shafts while the air space between the bushings efficiently dissipates heat. By using one or more springs 98, 130 to normally disengage gears in the gear train, the motor may be allowed to run continuously s for protracted periods of time without causing rotation of the lower or upper drive shafts, gears or the rotary straining and juicing basket while the rotary parts of the juicer attachment remain stationary. The associated heat build up and wear of all of the bushings 44, 60, 110, 112 is thereby significantly reduced as compared with prior designs.

The disclosed co-axial arrangement of the telescopically engaged lower and upper drive shafts and gears which effectuate an 18:1 speed reduction from the speed of an exemplary electric motor output shaft aligned with the lower and upper drive shafts significantly reduces heat, noise and wear and of course the specific arrangement disclosed is by way of example rather than limitation.

Persons skilled in the art will readily appreciate that various additional modifications can be made from the presently preferred embodiment thus the scope of protection is intended to be defined only by the appended claims.

1. A juicer attachment for mounting on a housing containing a motor having a rotary drive shaft, said attachment comprising:
a) an upper cover having a side wall and a bottom wall having an aperture for receiving a drive shaft;
b) a lower cover having an aperture for receiving a drive shaft, said lower cover being attached to said tipper cover, said upper and lower covers defining a gear chamber;
c) an upper drive shaft slidably mounted in said aperture in said upper cover;
d) a rotary straining and juicing basket supported on said upper drive shaft in said upper cover,
e) a lower drive shaft telescopically engaged with and rotatable relative to said upper drive shaft, said lower drive shaft having a drive coupling thereon for engaging a drive coupling driven by a motor;
f) spaced shaft bushings between said lower drive shaft and said upper drive shaft and a heat dissipating cavity between said bushings;
g) gears in said gear chamber for transferring power from said lower drive shaft to said upper drive shaft; and
h) at least one spring biasing at least one of said upper anti lower drive shafts upwardly relative to said covers to normally disengage at least two gears in said chamber.

2. The juicer attachment of claim 1, further comprising a collar on said upper drive shaft and said at least one spring comprises a first spring engaging said collar on said upper drive shaft.

3. The juicer attachment of claim 2, further comprising an upper mounting bushing seated in said aperture in said upper cover, said upper mounting bushing receiving a lower end of said upper drive shaft.

4. The juicer attachment of claim 3, further comprising a collar on said upper mounting bushing, said collar providing a lower seat for said first spring.

5. The juicer attachment of claim 1, wherein part of said lower drive shaft is slidably received in said upper drive shaft.

6. (canceled)

7. The juicer attachment of claim 5, further comprising a thrust ball in said upper drive shaft, said thrust ball in contact with said lower drive shaft and said upper drive shaft.

8. The juicer attachment of claim 2, further comprising a lower mounting bushing in said aperture in said lower cover, said lower mounting bushing receiving said lower drive shall, a pinion gear affixed to said lower drive shaft, and a second spring on said lower drive shaft seated between said lower mounting bushing and said pinion gear to normally lift and disengage said pinion gear from another gear.

9. The juicer attachment of claim 8, wherein said lower mounting bushing is lubricious and includes a washer engaged With said second spring.

10. The juicer attachment of claim 1, wherein said gears cause said lower drive shaft, when rotating at about 3600 RPM, to rotate said upper drive shaft at a reduced speed of about 200 RPM.

11. An electric juicer comprising: a housing containing an electric motor having a rotary drive shaft extending upwardly from said housing and a juicer attachment affixed to said housing, said juicer attachment including:
a) an upper cover having a side wall and a bottom wall having an aperture for receiving a drive shaft;
b) a lower cover having an aperture for receiving a drive shaft, said lower cover attached to said upper cover, said upper and lower covers defining a gear chamber;
c) an upper drive shaft slidably mounted in an aperture in said upper cover;
d) a rotary straining and juicing basket supported on said tipper drive shaft in said upper cover,
e) a lower drive shaft telescopically engaged with and rotatable relative to said upper drive shaft, said lower drive shaft having a coupling thereon for engaging a drive coupling driven by said motor;
f) spaced shaft bushings between said lower drive shaft and said upper drive shaft and a heat dissipating cavity between said bushings;
g) gears in said gear chamber for transferring power from said lower drive shaft to said upper drive shaft; and
h) at least one spring biasing at least one of said upper and lower drive shafts upwardly relative to said covers to normally disengage at least two gears in said chamber, said motor drive shaft being coupled to said lower drive shaft.

12. The juicer of claim 11, further comprising a collar on said upper drive shaft and said at least one spring comprises a first spring engaging said collar on said upper drive shaft.

13. The juicer of claim 12, further comprising an upper mounting bushing in said aperture in said upper cover, said upper mounting bushing receiving a lower end of said upper drive shaft.

14. The juicer of claim 13, further comprising a collar on said upper mounting bushing, said collar providing a lower seat for said first spring.

15. The juicer of claim 11, wherein part of said lower drive shaft is slidably received in aid upper drive shaft.

16. (canceled)

17. The juicer of claim 15, further comprising a thrust ball in said upper drive shaft, said thrust ball being in contact with said lower drive shaft and said upper drive shaft.

18. The juicer of claim 12, further comprising a lower mounting bushing in said aperture in said lower cover, said lower mounting bushing receiving said lower drive shaft, a pinion gear affixed to said lower drive shaft and a second spring on said lower drive shaft seated between said lower mounting bushing and said pinion gear to normally lift and disengage said pinion gear from another gear in said chamber.

19. The juicer of claim 18, wherein said lower mounting bushing is lubricious and includes a washer engaged with said second spring.

20. The juicer of claim 19, wherein said gears cause said lower drive shaft rotating at about 3600 RPM to rotate said upper drive shaft at a reduced speed of about 200 RPM.

21. The juicer of claim 11, wherein said housing containing said electric motor is connected to said attachment by latches.

22. The juicer attachment of claim 1, wherein said lower drive shaft includes an upwardly extending rod of reduced diameter, said spaced shaft bushings being in contact with said rod.

23. The juicer of claim 11, wherein said lower drive shaft includes an upwardly extending rod of reduced diameter, said spaced shaft bushings being in contact with said rod.
